(19) United States
(12) Patent Application Publication
(10) Pub. No.: US 2009/0156189 A1
(43) Pub. Date: Jun. 18, 2009

(54) Configuration of Networked Devices via mobile stations

(76) Inventor: Lars Peter Ohman, Enebyberg (SE)

Correspondence Address: ERICSSON INC., 6300 LEGACY DRIVE, M/S EVR 1-C-11, PLANO, TX, 75024, US

(21) Appl. No.: 11/719,901

(22) PCT Filed: Nov. 22, 2004
(86) PCT No.: PCT/EP2004/013240

§ 371 Date: May 22, 2007

(51) Int. Cl. H04M 3/00; H04W 4/12; H04W 4/00

(52) U.S. Cl. 455/418; 455/466; 370/328

(57) ABSTRACT

A method is proposed for configuring a wireless enabled device using a mobile station that is adapted to communicate with a core network portion of a mobile communications network. The mobile station is also arranged to support communication via a wireless interface and the device is capable of communicating via this wireless interface. The method includes the steps of: establishing communication with a support center via the mobile communications network core network portion; receiving a message containing configuration data for the device from the call center; establishing an unlicensed radio link with the device; and transmitting the configuration data to the device via said unlicensed wireless link. By using the mobile phone or other mobile communications device as an interface for configuration data, the end user is relieved of all further interactions and requires no specific knowledge or experience to achieve the configuration and installation of the device.

### FIELD OF INVENTION

The invention relates to a method of remote configuration of devices capable of communicating via a wireless link.

### BACKGROUND ART

Unlicensed wireless technologies such as Wireless LAN, specifically Wi-Fi or Bluetooth provide a convenient and relatively cheap way of networking buildings that are not equipped with the necessary cabling. Home or residential wireless networks, in particularly, are becoming more widespread as the availability of broadband networks increases and the various devices, such as modems, and routers become more affordable. However, the installation of wireless enabled devices in a home network can be a difficult and lengthy process, particularly for individuals without a detailed knowledge of the technology, which in a home environment is often the case. Similar problems can be encountered when installing other electrical equipment, such as televisions or computers. These devices also may be equipped with some form of wireless communication interface, such as a radio or infrared interface. Conventionally, vendors of this kind of equipment will offer on-line or telephone assistance with the installation. But online assistance presupposes that the network is up and running and a telephone help line still requires the subscriber to have the necessary knowledge and ability to understand and implement the instructions. There is thus a need for a method of configuring such wireless-enabled devices that is less dependent on the skill of the end user and hence less susceptible to errors.

### SUMMARY OF THE INVENTION

The above and other objects are achieved in a method in accordance with the appended claims.

Specifically, the invention resides in a method of configuring a device adapted to communicate via a communication interface using a mobile station that is adapted to communicate with a core network portion of a mobile communications network. The mobile station is also arranged to support communication via the same communication interface as the device. The method includes the steps of: establishing communication with a support center via the mobile communications network core network portion; receiving a message containing configuration data for the device from the call center; establishing a communication link with the device; and transmitting the configuration data to the device via said communication link.

By using the mobile phone or other mobile communications device as an interface for configuration data, the end user is relieved of all further interaction and requires no specific knowledge or experience to achieve the configuration and installation of the device.

Preferably the communication interface is a wireless interface, which may be an unlicensed radio interface, such as WLAN, Bluetooth, DECT or the like. Alternatively, the wireless interface may be an optical interface, such as an infrared interface.

The initial step of establishing communication with the service center preferably consists of putting through a call to the service center from the mobile station with a configuration request for the device. Alternatively, however, this may be achieved by using the mobile station to send an SMS with the configuration request.

Advantageously the configuration data message from the service center may be in the form of an SMS. In this way the end user is required simply to accept the SMS. The establishment of a communications link and forwarding of the configuration data contained in the SMS is then achieved by the end user forwarding the configuration SMS to the device at a previously obtained number.

In accordance with an alternative embodiment, the configuration data message from the service center is sent over a data link established with the mobile station. In this case the mobile station will receive a data mobile call from said service center and the end user is required simply to accept this call for the establishment of the point to point data link to be effected. This method has the particular advantage that all further communication with the device is implemented by the service center.

A similar advantage is obtained when communication between the mobile station and the service center uses a packet radio service such as the General Packet Radio Service GPRS. In this case, the step of receiving a message containing configuration data for the device from the call center includes the step of the mobile station initiating a packet radio session with said call center.

Preferably, the mobile communications network includes an unlicensed radio access network connected to the core network portion and adapted to communicate with mobile stations via an unlicensed radio link. The step of establishing communication with a support center via the mobile communications network core network portion then preferably includes establishing a connection with said unlicensed radio access network via the unlicensed radio interface.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically depicts the connections between a mobile station, a remote service center and a network device in need of configuration,

FIG. 2 is a block diagram schematically depicting the functional layout of a mobile station in accordance with the present invention,

FIG. 3 schematically depicts parts of a GSM network with an unlicensed-radio access network,

FIG. 4 illustrates the exchange of messages between a mobile station, service center and network device during configuration using an SMS, and

FIG. 5 illustrates the exchange of messages between a mobile station, service center and network device during configuration using a data connection via the mobile station.

### DETAILED DESCRIPTION OF THE DRAWINGS

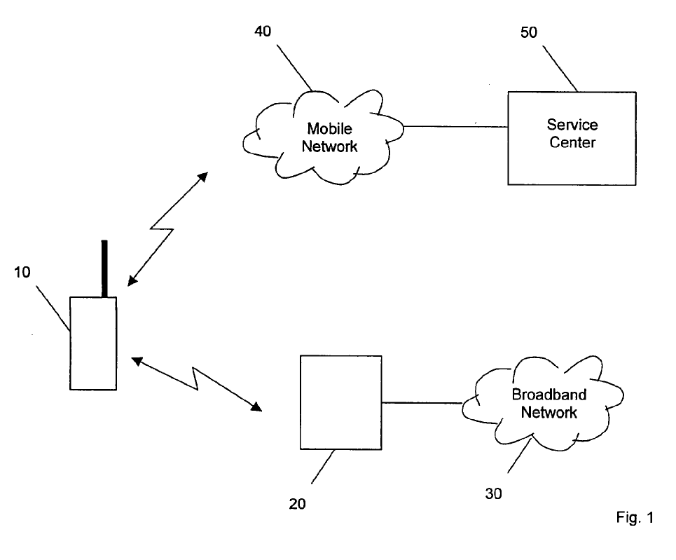

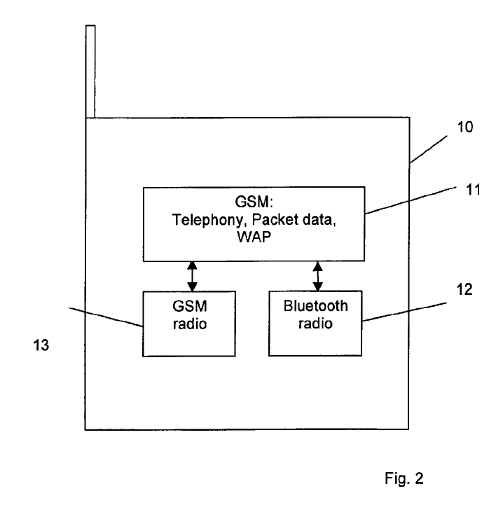

FIG. 1 schematically illustrates the arrangement required to effect remote installation and configuration of a device for use in a communications network, such as an ADSL modem, that supports communication via an unlicensed radio interface using a mobile station 10. Such devices will hereinafter be referred to as network devices. The mobile station 10, or mobile phone is capable of supporting communication over a wireless interface. In the embodiment described here, this interface is an unlicensed radio link, however it will be understood by those skilled in the art that other wireless interfaces supported by the mobile station, such as an infrared or other optical link may also be used. The unlicensed radio interface may use any available unlicensed radio technology, such as Bluetooth, wireless LAN, DECT or similar interface. The network device 20 is shown connected to a broadband network 30, but requires configuration to communicate over this network. The connection may be via a cable or a wireless connection to a port in the broadband network. The network device may be connected to other home network elements, such as a pc or the like. The mobile station 10 is also capable of communicating with a mobile communications network 40, which provides a connection to a service center 50, either directly or via a further public or private communications network or networks. The network device 20 supports communication using the same unlicensed radio interface as that used by the mobile station 10. The structure of the mobile station 10 is shown in more detail in FIG. 2.

FIG. 2 depicts a simplified block diagram of the structure of the mobile station 10. In the present embodiment, the mobile phone 10 supports communication with the mobile communication network 40 via a standard air interface, such as the GSM Um interface, and alternatively via the unlicensed radio interface. The mobile station 10 includes the standard upper layer functions 11 required for any mobile operating in a GSM system. These specifically include the connection management layer and mobility management layer. These layers 11 handle the telephony and, if present, packet data transmission, such as General Packet Radio Service (GPRS) functions and wireless access protocol (WAP) functions. The General Packet Radio Service GPRS is a packet service that enables data to be sent and received across a mobile network. It is typically used to enable Internet applications such web browsing as well as file transfer but may also be used for voice-over-IP. These upper layer functions 11 connect with a GSM radio function module 13 as in a conventional GSM mobile terminal. In addition to this GSM radio module 13, the mobile phone 10 additionally includes a further radio module 12 for the unlicensed radio interface. By unlicensed-radio is meant any radio protocol that does not require the operator running the mobile network to have obtained a license from the appropriate regulatory body. The radio interface may utilise any suitable unlicensed-radio protocol, for example a wireless LAN (W-LAN) protocol or Digital Enhanced Cordless Telecommunications (DECT). Preferably, however, Bluetooth radio is utilised, which has a high bandwidth and lower power consumption than conventional public mobile network radio.

The Bluetooth standard specifies a two-way digital radio link for short-range connections between different devices. Devices are equipped with a transceiver that transmits and receives in a frequency band around 2.45 GHz. This band is available globally with some variation of bandwidth depending on the country. In addition to data, up to three voice channels are available. Each device has a unique 48-bit address from the IEEE 802 standard. Built-in encryption and verification is also available.

The Bluetooth radio module 12 communicates directly with the upper layer functions 13. The upper layer functions 13 thus transmit the same messages to a mobile core network portion whether using the GSM radio function module 13 or the Bluetooth radio function module 12. This allows the subscriber to perceive no change in the service obtainable whether the mobile terminal is in the coverage area of an access point (AP) 301 or a base station subsystem 101. While the conventional mobile communication system is GSM in this embodiment, this is give by way of example only. It will be understood that any licensed mobile communication system can be used in place of the GSM standard.

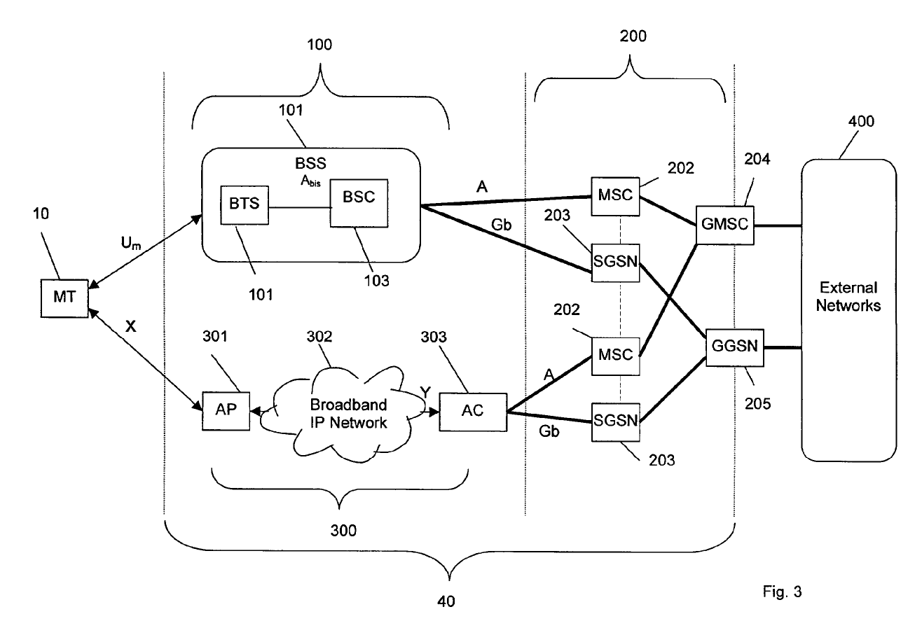

The connection between the mobile station 10 of FIG. 2 and the mobile communication network 40 is illustrated schematically in FIG. 3.

FIG. 3 schematically depicts parts of a conventional GSM network extended by unlicensed radio access portions. This network is essentially divided into a core network portion 200 which is connected to several conventional GSM access portions or base station subsystems BSS 100, only one of which is illustrated in the figure. In addition, several unlicensed radio access portions 300 are connected to the core network portion 200, but again only one unlicensed radio access portion is illustrated. For the purposes of the present embodiment the GSM network supports both standard GSM telephony services and also packet service or General Packet Radio Service functions. To this end, the elements of the core network 200 illustrated in the figure include the mobile switching centers or MSCs 202, which communicate with the access portions 100, 300 via the standard A-interface and GPRS switching nodes SGSN 203, which communicate with the access portions 100, 300 via the Gb-interface. The function and structure of these conventional architecture elements are known to those skilled in the art and will not be described in further detail here. It will be appreciated by those skilled in the art that the core network portion 200 contains other elements not illustrated in FIG. 3. These will not be referred to here, as they are not relevant to the present invention.

The core network portion 200 provides access to other external networks 400, including other mobile and fixed-line networks, such as ISDN and PSTN networks, packet and circuit switched packet data networks such as intranets, extranets and the Internet through gateway mobile service switching centres GMSCs 204 and gateway GPRS support nodes GGSNs 205.

In the conventional GSM access network 100 the access portion essentially consists of a base station subsystems BSS 10. Each base station subsystem BSS 10 includes a base station controller BSC 103, which communicates with the core network nodes 202, 203 via the standard A and Gb-interfaces and with one or more base transceiver stations BTS 101 via the defined A_{bis} air interface 102. The base transceiver stations 101 communicate with the mobile stations 10 over the GSM standard Uₘ radio air interface. It will be understood that while the BTS 101 and BSC 103 are depicted as forming a single entity in the BSS 10, the BSC 103 is often separate from the BTSs 101 and may even be located at the mobile services switching centre MSC 202.

The unlicensed radio access portion 300 also enables the mobile station 10 to access the GSM core network portion, and through this, other communication networks via the unlicensed-radio interface X, which in the present embodiment is a Bluetooth radio interface.

The access network portion 300 is accessed by the mobile station 10 via access points AP 301 that are adapted to communicate across the Bluetooth interface X. Only one access point AP 301 is illustrated in FIG. 3, but it will be understood that many hundreds of these elements may be included in the unlicensed-radio access network 30. The access point 301 handles the radio link protocols with the mobile station MS 1 and contains radio transceivers that define a cell in a similar manner to the operation of a conventional GSM base station transceiver BTS 101. All communication via the access points AP 301 is controlled by an access controller AC 303, which communicates with a mobile service switching centre MSC 202 over the GSM standard A interface and a GPRS support node SGSN 203 over the Gb interface. The joint function of the access point AP 301 and the access controller AC 303 emulates the operation of the BSS 10 towards the MSC 202. In other words, when viewed from the elements of the core network 20 such as the mobile service switching centre MSC 202, the access network portion 30 constituted by the access points AP 301 and the access controller AC 303 looks like a conventional access network portion 10.

The interface between the access point AP 301 and the access controller AC 303 is provided by a packet-switched broadband network, which may be a fixed network. The access point 301 is intended to be a small device that a subscriber can purchase and install in a desired location such as the home or an office environment to obtain a fixed access to the mobile network. However, they could also be installed by operators in traffic hotspots. In order to reduce the installation costs on the part of the operator, the interface between the access point 301 and the access controller 303 preferably exploits a connection provided by an already existing network 302. Suitable networks might include those based on ADSL, Ethernet, LMDS, or the like. Home connections to such networks are increasingly available to subscribers while commercial access points to such networks are becoming widespread in public and commercial buildings. Although not shown in FIG. 3, the access point AP 301 will be connected to a network terminal giving access to the network 302, while the access controller AC 303 may be connected to an edge router ER of the network 302 that also links the network 302 to other networks such as intranets and the internet. The Internet protocol, IP, is used for communication over the network 302 to render the transport of data independent of the network type.

The link between the mobile station MS 10 and the access controller AC 303 over the broadband IP network 302 is always open, so that this connection is always available without the need for reserving a channel. Specifically, a transport protocol is utilised that maintains a connection state between a mobile station MS 1 and the access controller AC 303. One suitable transport protocol is the Transmission Control Protocol (TCP), however, other protocols such as the User Datagram Protocol (UDP) or the Signalling Control Transfer Protocol could also be used. While the network 302 is preferably an IP-based network, ATM-based networks could also be used. In particular when DSL technologies are used in this network, they could be used directly on top of the ATM layer, since they are based on ATM. Naturally, an ATM based network could also be used to transport IP, serving as a base layer.

The applications that run on the mobile station MS 10 on top of the public mobile network radio interfaces also run on top of Bluetooth radio between the mobile station 10 and the access point AP 301.

The access point AP 301 is installed by plugging it in to a port of a suitable modem, such as an ADSL or CATV modem, to access the fixed network 302. Alternatively, the access point AP 301 could be integrated in such a modem. The port is in contact with an intranet that is either bridged or routed on the IP level.

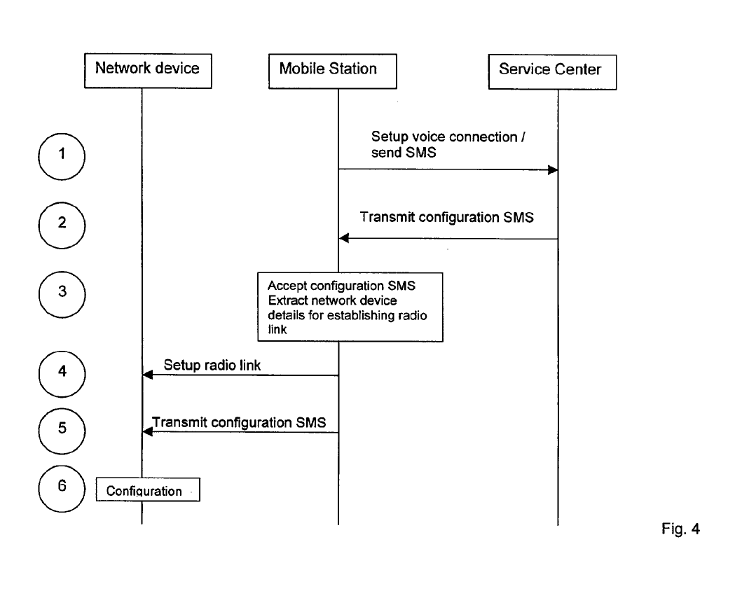

Turning again to FIG. 1 it is assumed that the end user has recently acquired the network device 20 and wishes to install this in the home network, for example, to provide a connection with the external broadband network 30. In accordance with the invention, assistance with the installation and configuration of the network device 20 is achieved by using the mobile phone to interface with both the service center 50 and the network device 20 and to install the required configuration data. This will be described in accordance with a first embodiment of the invention with reference to the signalling diagram of FIG. 4. Initially, at event 1, the end user contacts the service center 50. This may be achieved by the user sending a message to the service center using a voice connection, by transmitting an SMS or via the Internet. Alternatively, this step may be performed when the user visits a store, for example when purchasing the device. When the end user sets up a voice connection the contact number of the mobile phone will have to be communicated. In the case of an SMS, the number of the mobile station is contained in the SMS; similar information is transmitted when the request is sent via the Internet. The contact number of the service center will be supplied with the network device 20. In response to this initial request, the service center transmits a return SMS containing the configuration data for the network device 20 at event 2. The end user must accept this configuration SMS, after which the mobile station 10 extracts the contact data of the network device necessary to establish a radio link at event 3. Alternatively, this data may be supplied with the network device 20. At event 4 the mobile station establishes a radio link with the network device over the unlicensed radio interface. At event 5, the mobile station forwards the configuration SMS via this interface. Using the data contained in the SMS the network device is configured at event 6.

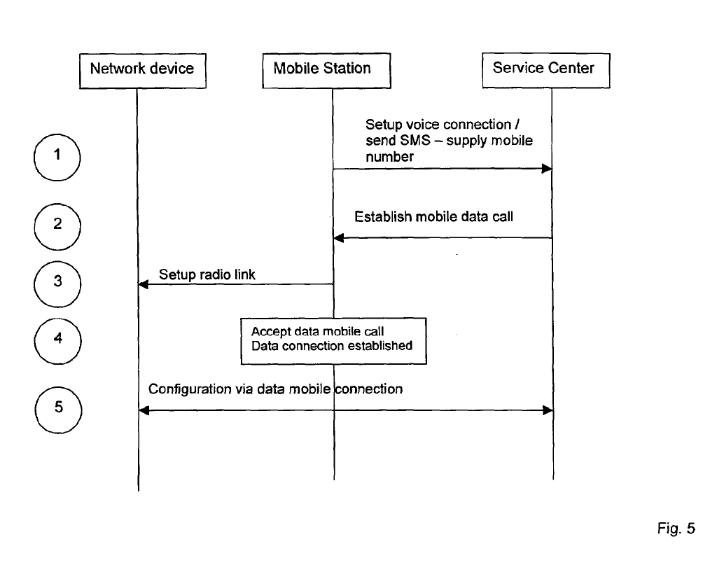

In an alternative embodiment of the invention, the configuration is performed remotely from the service center 50 using the mobile station 10 as a connection to the network device 20. This will be described with reference to FIG. 5. This method starts in the same manner as that described with reference to FIG. 4, specifically, the mobile station calls the service center with a demand for configuration data or sends an SMS to this effect and communicates the number of the mobile station at event 1. In response to the configuration request, the service center sends a mobile or circuit-switched data call to the number communicated in order to set up a point-to-point data connection at event 2. At event 3, the mobile station 10 sets up a radio link with the network device over the unlicensed radio interface. If the data call sent at event 2 is accepted by the mobile station, the data connection is established at event 4. The service center can then communicate directly over the established data link and unlicensed radio link with the network device to configure this device correctly. A data link may also be initiated by the mobile station rather than the service center.

In a modification of this method, communication between the mobile station 10 and service center 50 can be achieved by the exchange of data packets, for example using the General Packet Radio Service GPRS. In this case, the GPRS connection must be initiated by the mobile station 10, which will be allocated an IP address. This IP address must then be communicated to the service center 50 to enable the exchange of data packets.

In all cases it will be understood that the mobile station 10 may establish a connection with the service center 50 via the mobile communications network 40 using either the conventional GSM access network 100 or the unlicensed radio access network 300, depending on which is available.

It will be understood that all methods require a minimum of knowledge and intervention on the part of the end user. The mobile station 10 is used as an interface for transmitting the configuration data to the network device. The end user is required simply to accept an SMS and forward this to the correct number or alternatively simply to accept a data call from, or to establish a GPRS call with, the service center. On receipt of this call, the mobile station establishes an unlicensed radio link with the network device without further intervention by the end user.

In the above embodiment the invention is described with reference to the configuration of a network device. However, it will be understood by those skilled in the art that the invention can be applied to any device equipped with a wireless interface that is compatible with that supported by a mobile station.

1. A method of configuring a device for communicating via a communication interface using a mobile station adapted to communicate with a core network portion of a mobile communications network and arranged to support communication via said communication interface, said method including the steps of:
establishing communication with a support center via said mobile communications network core network portion,
receiving a message containing configuration data for said device from said call center,
establishing a link with said device via said communication interface; and
transmitting said configuration data to said device via said communication interface link.

2. The method in claim 1, wherein said step of establishing a communication interface link with said device includes establishing a wireless communication link.

3. The method claim 1, wherein said step of establishing a communication interface link with said device includes establishing an unlicensed radio interface link.

4. The method in claim 1, wherein said step of establishing a communication interface link with said device includes establishing an infrared link.

5. The method in claim 1, wherein said step of establishing communication with a support center via said mobile communications network core network portion includes: calling said service center from said mobile station with a configuration request for a device.

6. The method in claim 1, wherein said step of establishing communication with a support center via said mobile communications network core network portion includes: sending an SMS to said service center from said mobile station with a configuration request for a device.

7. The method in claim 1, wherein said step of receiving a message containing configuration data for said device from said call center includes the step of: receiving and accepting a configuration SMS from said service center.

8. The method in claim 7, wherein the step of establishing a communication interface link with said device and transmitting said configuration data to said device via said communication interface link includes forwarding said configuration SMS to said device.

9. The method in claim 1, wherein said step of receiving a message containing configuration data for said device from said call center includes the step of: receiving a data mobile call from said service center and accepting said data mobile call to establish a point to point data link with said service center.

10. The method in claim 1, wherein said step of receiving a message containing configuration data for said device from said call center includes the step of: initiating a packet radio session with said call center.

11. The method in claim 1 b, wherein said mobile communications network includes an unlicensed radio access network connected to said core network portion for communicating with mobile stations via an unlicensed radio link, and wherein said method step of establishing communication with a support center via said mobile communications network core network portion includes establishing a connection with said unlicensed radio access network via said unlicensed radio interface.
